(19) United States
(12) Patent Application Publication
(10) Pub. No.: US 2025/0375058 A1
(43) Pub. Date: Dec. 11, 2025

(54) PORTABLE INSTANT COFFEE KIT AND METHOD FOR USE

(71) Applicant: Tracey Denise Flemming, Sumter, SC (US)

(72) Inventor: Tracey Denise Flemming, Sumter, SC (US)

(21) Appl. No.: 19/203,402

(22) Filed: May 9, 2025

Related U.S. Application Data
(60) Provisional application No. 63/648,349, filed on May 16, 2024.

(51) Int. Cl. A47J 31/00; A23F 5/24; B65D 23/00

(52) U.S. Cl. CPC A47J 31/005; A23F 5/243; B65D 23/00

(57) ABSTRACT

A portable instant coffee kit comprises a beverage container assembly and a coffee beverage concentrate. The container assembly comprises a container and a container lid configured to seal the container for mixing a beverage therein. The container has an exterior surface, an interior surface, and at least one interior or exterior fill line. The container may be made of a transparent or translucent material. The container may be made of an opaque material and include at least one interior fill line. A user may add to a concentrate in the container, a predetermined amount of a liquid defined by a container fill line, the liquid comprising hot or cold water, milk, cream, coffee or combinations thereof, and mixing the concentrate and liquid contents of the sealed container to quickly prepare a coffee or espresso beverage. The concentrate may be provided in a 3-ounce bottle.

### FIELD OF THE INVENTION

The present invention relates generally to portable beverage containers, and more particularly to a portable instant coffee kit and method for use.

### BACKGROUND OF THE INVENTION

Many consumers have a great affinity for coffee. Coffee beverages, whether on sale, ready to drink, instant, or coffee beans are a significant sector of the consumer food and beverage market. Convenient sources of coffee continue to be sought by many consumers. In particular, coffee enthusiasts on the go are always in search of a quick, convenient cup of coffee prepared just the way they like it.

Options exist which provide instant coffee beverages including espresso which include additives capable of inducing a foam as well as a coffee aroma. However, additives are not ideal and may interfere with coffee flavor and cause consumers to experience negative long term health effects.

In addition, instant coffee products may be provided in powder or tablet form, which may be added to water to produce a coffee beverage intended to have the taste and smell of freshly brewed coffee. Such products may include a sweetener and/or creamer component. Unfortunately such products may contain unwanted chemicals which may cause an unpleasant aftertaste. These products with artificial components may also cause consumers to experience negative health effects with long term use.

Coffee preparation products exist which provide coffee in a tea bag like structure capable of use with either hot or cold water.

Many premade coffee products exist which contain multiple ingredients, sweeteners, and artificial ingredients which consumers do not want.

Currently available pre-made coffee beverages do not provide an option to a consumer to choose the type of milk that is used to make their coffee/latte beverage (i.e. organic, skim, 1%, 2%, whole, almond, lactose free). The manufacturer has already made this choice for the consumer. Therefore, if a consumer is lactose intolerant or simply prefers a milk product other than the one that was used, then the consumer is out of luck. Previous options therefore leave a large part of the coffee drinking consumers that would like to be able to grab a coffee beverage on-the-go unable to do so.

Ideally, it would be extremely useful to be able to provide a way to make flavorful coffee that may be quickly prepared at home or capable of use when traveling.

Accordingly, there is need for a solution to at least one of the aforementioned problems. For instance, there is an established need for a convenient, portable instant coffee beverage.

### SUMMARY OF THE INVENTION

The present invention is directed to a portable instant coffee kit, or instant coffee starter kit. The portable instant coffee starter kit enables a user to quickly make a cup of coffee or espresso by adding hot or cold water to a prepared coffee product. The portable instant coffee starter kit may be used at any location, and “on the go”.

The portable instant coffee kit may comprise a 12-ounce beverage container and a coffee beverage concentrate. The container may comprise a container body and a container lid. The lid is configured to seal the container for mixing a beverage therein. The container body may have an exterior surface, an interior surface, and at least one fill line. The container body may be made of a transparent or translucent material. In some embodiments, the container body may be made of an opaque material, and may have at least one interior fill line. A user may add to a coffee beverage composition in the container, a predetermined amount of a liquid defined by a container fill line, the liquid comprising hot or cold water, milk, cream or combinations thereof, and mixing the composition and liquid contents of the sealed container to quickly prepare a coffee or espresso beverage.

The present invention may provide an instant coffee starter kit comprising a 12-ounce beverage container and a concentrated coffee beverage composition in liquid form. The container may comprise a container body having an opening, and a container lid configured to seal the container for mixing a beverage therein. A removable seal may be affixed to the container opening to seal the concentrated coffee beverage composition in the container, the removable seal being secure but easily removable prior to use. The container body may have an exterior surface, an interior surface, and at least one fill line. The container body may be made of a transparent or translucent material, or an opaque material. A user may remove the removable seal from the container opening, add to a coffee beverage composition in the container, a predetermined amount of a liquid defined by a container fill line, and mix the composition and liquid contents of the closed container to quickly prepare a coffee or espresso beverage. The liquid may comprise hot or cold water, milk, cream or combinations thereof. The present invention provides a coffee or espresso starter drink for which the user can customize the flavor.

In one aspect, the present invention provides an instant coffee starter kit comprising a prepared quick starter coffee product in a convenient beverage container. The prepared coffee product may comprise a coffee beverage concentrate in a liquid form. The coffee beverage may be regular coffee or espresso. A user may add hot or cold water to the container to quickly prepare a cup of quick starter coffee or espresso beverage in the container.

In one aspect, the present invention provides an innovative single serving liquid latte starter which will allow the user to have a quick way to make coffee or espresso. The starter may be packaged in a 12-ounce container with a removable lid. The container and removable lid may have a threaded connection. The coffee starter may comprise a liquid coffee composition further comprising two (2) ounces of espresso and two (2) ounces of a flavored sweetener syrup. The flavored syrup may comprise any suitable syrup such as, for example without limitation, Torani® flavored sweetener. In use, a user may screw off the bottle lid, add eight (8) ounces of milk or water, screw the lid back on the container and shake well before consuming.

In one aspect, a coffee “starter” may be provided in a small container (similar to “5 hour energy”), which is capable of use to make a hot or cold espresso by adding water and/or milk with sweetener to a portable beverage container (like a “Thermos®” container).

In one aspect, the coffee starter kit of the present invention provides a fast personalized, customized, inexpensive, convenient option. The present invention provides fast custom espresso to go in a portable beverage container.

In one aspect, the present invention provides a single serving liquid latte starter of two types.

In one aspect, a first type provides a bottle which contains the liquid starter to which a user or consumer may add eight (8) ounces of any suitable hot or cold liquid, such as for example without limitation, milk, (i.e. organic, skim, 1%, 2%, whole, almond, lactose free), or water. After adding the liquid, the user may simply replace the lid, shake the bottle, and enjoy the beverage.

In one aspect, a second type provides a three (3) ounce bottle which contains a liquid starter composition. The liquid starter composition may be poured in a suitable drinking vessel such as a cup or mug. The user may then add to the vessel eight (8) ounces of liquid, such as warm or cold water or milk (i.e. organic, skim, 1%, 2%, whole, almond, lactose free), stir the beverage and enjoy drinking an easily prepared beverage.

In one aspect, the present invention provides a coffee beverage concentrate composition comprising one (1) ounce of brewed espresso and two (2) ounces of a beverage sweetener. The brewed espresso may comprise water and finely ground espresso beans.

In one aspect, the present invention provides a method for preparing a coffee beverage concentrate composition. The method may comprise one or more of the following steps and combinations thereof.

A predetermined quantity of espresso beans is placed in a coffee grinder.

The grinder is set to fine grounds, and grinds the predetermined quantity of espresso beans.

The grinder then measures and dispenses from a dispenser a predetermined quantity of ground espresso coffee into a portafilter located below the dispenser. A tamper is used to pack the ground espresso coffee into the portafilter.

The portafilter is then placed into an espresso machine where hot water from the espresso machine is forced through the ground espresso and captured in 2 espresso brew pitchers, a first espresso brew pitcher and a second espresso brew pitcher. Each pitcher captures one shot of espresso. Each shot equals about 1 ounce of espresso.

A beverage bottle (or container) is provided, and a first shot of espresso (one (1) oz.) is poured into the beverage bottle.

Providing a liquid beverage sweetener and pouring up to about two (2) ounces of the liquid beverage sweetener into the beverage bottle.

After the sweetener is added to the beverage bottle, a tamper proof lid is screwed onto the bottle and tightened to seal the contents into the beverage bottle. The bottle and tamper proof lid may comprise any suitable commercially available bottle and lid. Optionally, a removable bottle seal may be affixed to the beverage bottle prior to securing the lid to the bottle.

In one aspect, providing a liquid beverage sweetener may comprise providing a commercially available liquid beverage sweetener which may be purchased and added to the espresso shot in the beverage bottle without a change to the chemical properties of the sweetener. It may merely be measured and poured into the beverage bottle with the espresso shot. For example, two pumps of syrup may be added to each bottle or container of brewed espresso.

In one aspect, providing a liquid beverage sweetener may comprise providing two (2) ounces of a custom sweetener blend. The custom sweetener blend may be prepared by modifying a sweetener component. The sweetener variations may include the following. The flavors of the sweeteners may be changed depending on the consumer likes and demand for product. The sweetener flavors may be mixed as may be determined by research and development of new varieties of lattes. However, the total amount of sweetener remains consistent (2 oz). Likewise, sugar free variations of the product may be produced as well. However, the total amount of sweetener remains the same (2 oz).

In one aspect, the present invention may comprise methods of packaging a beverage concentrate in a beverage container. All measuring and packaging may be done individually by hand. Alternatively, in response to an increased need for production, the measuring and packaging may be effected by machines capable of automating the production, measuring, filling and packaging of the beverage to a beverage bottle or container.

In one aspect, the beverage containers may be any suitable containers. A first type of suitable container may comprise a beverage container with a liquid beverage starter composition or concentrate therein, to which a quantity of additional liquid may be added. A second type of container may comprise a three-ounce bottle configured to retain a liquid starter composition or concentrate.

In one aspect, the first type of container is configured to retain a liquid starter or concentrate and to receive up to about eight (8) ounces of any suitable hot or cold liquid added by a user. Nonlimiting examples of the suitable hot or cold liquid may include milk, (i.e. organic, skim, 1%, 2%, whole, almond, lactose free), water, or coffee. After adding the liquid, the user may simply replace the lid, shake the bottle, and enjoy the beverage.

In one aspect, the container may comprise a beverage cup and a removable lid, the beverage cup being provided with at least one fill line.

In one aspect, the container may comprise a plastic beverage bottle with at least one fill line.

In one aspect, the container may comprise a cup assembly comprising a beverage cup with a removable lid. The beverage cup may have a volume of between about 8-20 ounces. The beverage cup may have at least one fill line to indicate the volume of liquid to be added to the product. The beverage cup may be configured to accommodate stirring with any suitable stirrer. The removable lid may be sealed to the cup with the product therein, with a sealing device, such as, for example without limitation, a plastic shrink wrap collar. The lid may have at least one opening with a removable opening seal to enable a user to secure the lid to the beverage cup and shake the cup to mix the product and the liquid, and remove the opening seal for use of the opening as a drinking hole.

In one aspect, the container may comprise a bottle assembly comprising a twelve (12) ounce clear plastic beverage bottle, which has a fill line on a side of the bottle indicating am amount of liquid to be added to the product. The bottle assembly may further comprise a tamper proof screw top lid. Optionally a seal may cover the bottle opening. Optionally a safety collar may be applied to the cover and bottle neck. A label may be provided on the container which includes product indicia such as product information and directions for use.

The second type of container may comprise a three (3) ounce bottle configured to retain a liquid starter composition. The three ounce container may comprise a clear, transparent or translucent material; or may comprise an aluminum bottle. The three ounce container may comprise a tamper proof screw top lid in place. Optionally the container may be provided with a seal covering the bottle opening. Optionally a safety collar may be applied to the cover and bottle neck. A label may be provided which includes product indicia and directions for use. In use, the optional safety collar may be removed, the lid may be removed, the optional seal may be removed, and the liquid starter composition may be poured in a suitable drinking vessel such as a cup or mug. The user may then add liquid, stir the beverage and enjoy drinking an easily prepared beverage.

The present invention provides an unprecedented option to a consumer to choose the type of milk that is used to make their coffee/latte beverage (i.e. organic, skim, 1%, 2%, whole, almond, lactose free). Currently available pre-made coffee beverages do not provide such an option as the manufacturer has already made this choice for the consumer. Therefore, if a consumer is lactose intolerant or simply prefers a milk product other than the one that was used, then the consumer is out of luck. Previous options therefore leave a large part of the coffee drinking consumers that would like to be able to grab a coffee beverage on-the-go unable to do so.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents an isometric view of a coffee kit in accordance with a first illustrative embodiment of the present invention;

FIG. 2 presents an exploded isometric view of a kit as in FIG. 1;

FIG. 3 presents an isometric front view of a beverage cup of the kit as in FIG. 1, with a liquid added to a fill line thereof to provide a coffee beverage;

FIG. 4 presents an isometric front bottom view of a beverage cup as in FIG. 3;

FIG. 5 presents a cross-section view of a cup of the coffee kit with the seal removed, and showing the interior and interior fill lines thereof;

FIG. 6 presents an isometric front view of a coffee kit in accordance with a second illustrative embodiment of the present invention;

FIG. 7 presents a rear elevation view of a kit as in FIG. 6;

FIG. 8 presents a rear elevation view of a kit as in FIG. 6 with a shrink collar;

FIG. 9 presents an isometric view of a coffee concentrate beverage container, cap and shrink collar in accordance with a third illustrative embodiment of the present invention;

FIG. 10 presents an isometric view of a coffee concentrate beverage container as in FIG. 9 showing the cap removed, and showing a removable container seal;

FIG. 11 presents an isometric view of a coffee concentrate beverage container and cap as in FIG. 9;

FIG. 12 is a flow chart of a method in accordance with a fourth illustrative embodiment of the present invention;

FIG. 13 is a flow chart of a method in accordance with a fifth illustrative embodiment of the present invention; and

FIG. 14 is a flow chart of a method in accordance with a sixth illustrative embodiment of the present invention.

Like reference numerals refer to like parts throughout the several views of the drawings.

### DETAILED DESCRIPTION

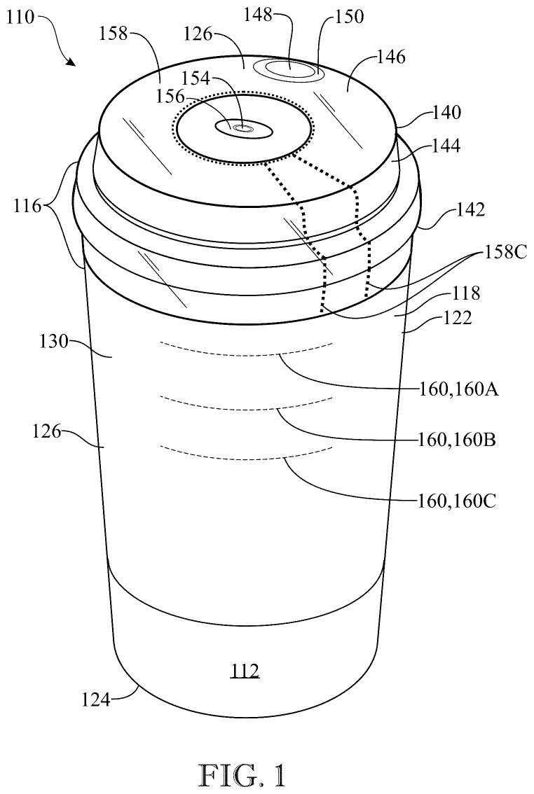

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed to a portable instant coffee kit and method for its use. The portable instant coffee starter kit enables a user to quickly make a cup of coffee or espresso by adding hot or cold water to a prepared coffee product. The portable instant coffee starter kit may be used at any location, and “on the go”.

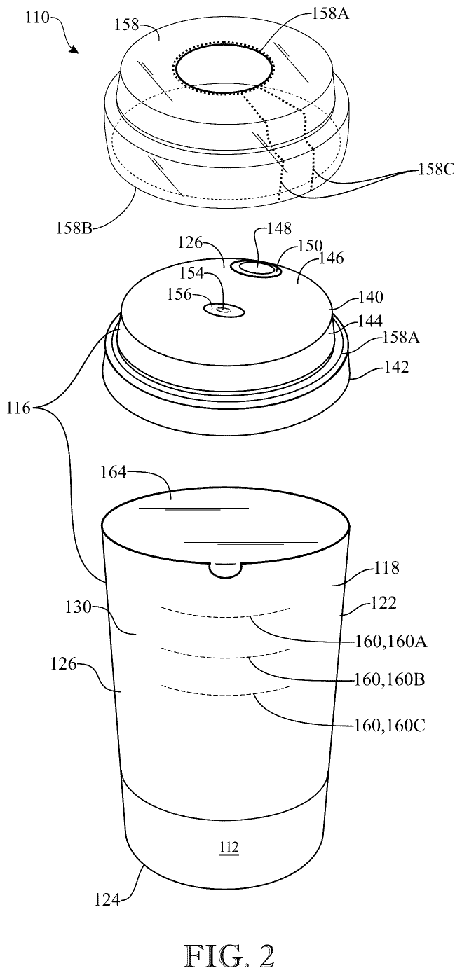

Referring initially to FIGS. 1-2, in an exemplary embodiment, a portable instant coffee kit 110 may comprise a coffee beverage concentrate 112 and a beverage container assembly 116. The beverage container assembly 116 may comprise a beverage container cup 118 and a container lid 140. As described in further detail hereinbelow, the beverage container assembly may comprise a beverage bottle with a tamper-proof threaded cap.

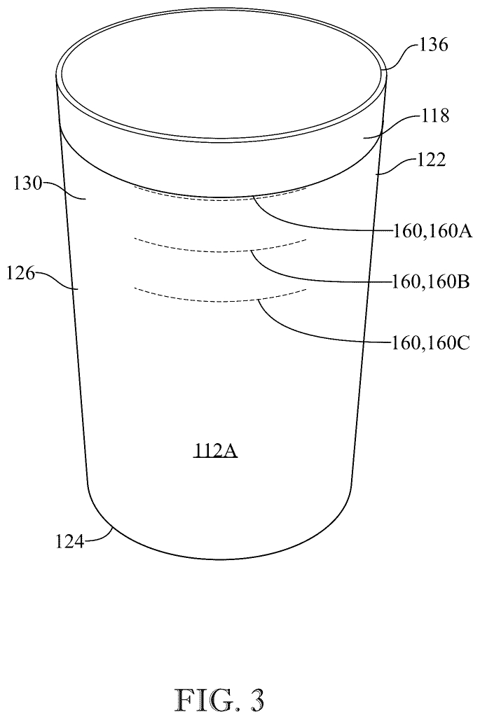

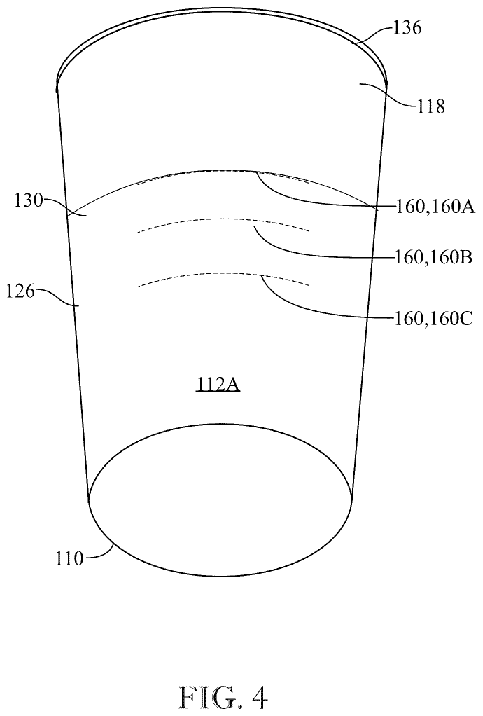

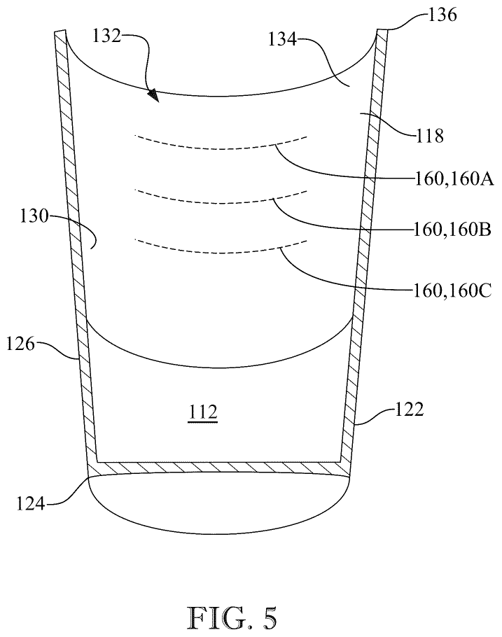

The beverage container cup 118 has a beverage container body 122. The beverage container body 122 may comprise a container base 124 and at least one container side wall 126 extending upwardly from the container base 124. The container base 124 and the at least one container side wall 126 define a container exterior surface 130, a container interior portion 132 (best seen at FIG. 5) and a container interior surface 134 (also best seen at FIG. 5). The container interior portion 132 is configured to hold a beverage concentrate 112 (as shown at FIGS. 1-2 and 5) or a beverage 112A (as seen at FIGS. 3-4). As shown at FIG. 4, the beverage container body 122 further includes an upper container rim 136 located at an upper portion of the at least one container side wall 126, the upper container rim 136 defining the beverage container opening. As shown at FIG. 2, a removable cup seal 164 may be provided to seal the beverage concentrate in the beverage container cup. The at least one side container wall 126 may include at least one fill line 160. A plurality of fill lines may be provided to permit a user to prepare a beverage with a desired strength/concentration. For example without limitation, three fill lines 160A, 160B, 160C may be provided.

Referring to FIGS. 1-2, the beverage container lid 140 may comprise a lower circular lid rim 142, at least one lid side wall 144, a lid top surface 146, and a beverage opening 148 located in the lid top surface 146. In some embodiments, the lid top surface 146 may include a removable beverage opening seal 150. In other embodiments, the lid top surface 146 may include a vent opening 154 with a vent opening seal 156. The lower circular lid rim 142 of the beverage container lid 140 is configured to securely but removably fit on the upper container rim 136 of the beverage container body 122.

As shown at FIG. 1, a safety collar seal 158 may be shrink-wrapped to seal the beverage container lid 140 over the beverage container 118. As shown at FIG. 2, the safety collar seal 158 has a safety collar top edge 158A, a safety collar bottom edge 158B, and a plurality of safety collar perforations 158C for use to open and remove the safety collar 158 seal for use of the kit 110.

The kit 110 and its components may be made of any suitable material. The beverage container 118 and lid 140 may be made of any suitable material. Nonlimiting examples of suitable materials may a translucent or a transparent plastic material. The container and lid may also be made of an opaque material including but not limited to opaque plastic materials and metals, such as, for example without limitation, plastics, stainless steel, aluminum and combinations thereof. As shown at FIG. 5, which provides a cross-section showing an interior view of the container 118, in embodiments in which the container is made of an opaque material, fill lines 160A, 160B, 160C may be provided on the container interior surface 134.

The container may be any suitable size, for example without limitation, a container having a volume of between about eight (8)—twenty (20) ounces. For example without limitation, the container may have a volume of 8 ounces, 12 ounces, 16 ounces, 20 ounces, or the like. The beverage container may be configured to retain a liquid beverage concentrate or liquid beverage starter and to receive between about four (4)—and sixteen (16) ounces of any suitable hot or cold liquid added by a user. For example without limitation, the container may have a volume of twelve (12) ounces, may contain three (3) ounces of liquid beverage concentrate or liquid beverage starter, and may receive up to about eight (8) ounces of a suitable hot or cold liquid. Nonlimiting examples of a suitable liquid may include milk, (i.e. organic, skim, 1%, 2%, whole, almond, lactose free), water or coffee.

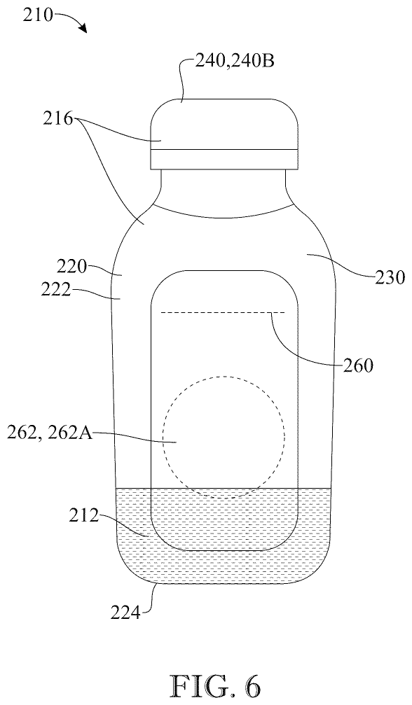

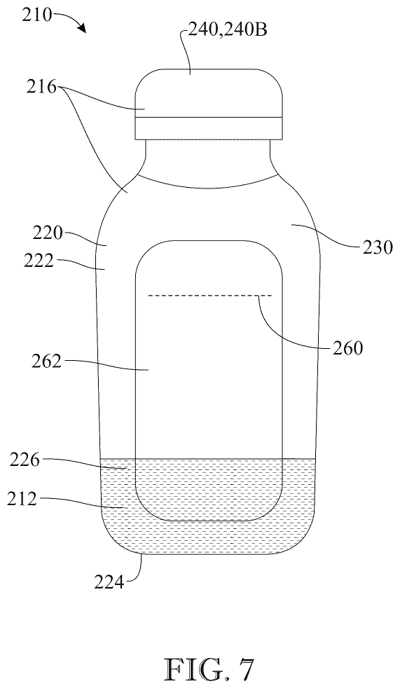

As shown at FIGS. 6-8, a nonlimiting example of a portable instant coffee kit 210 and beverage container assembly 216 is shown. Reference numerals which correspond to like elements of the beverage container assembly 116 heretofore described with respect to FIGS. 1-5 are designated by the same reference numerals in the 200-299 series in FIGS. 6-8.

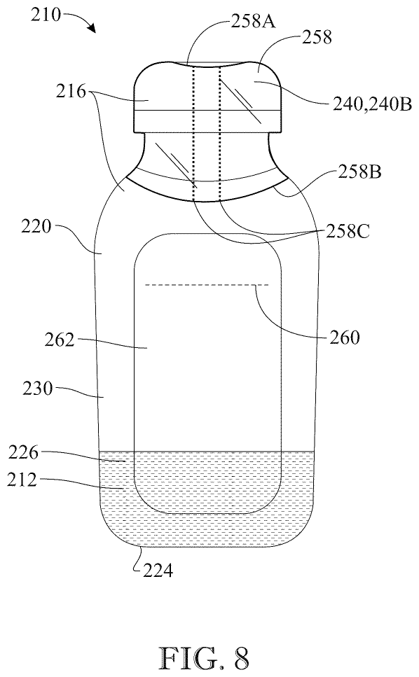

The beverage container assembly 216 may comprise a twelve (12) ounce clear plastic beverage bottle 220, which will have a fill line 260 on a side wall 226 of the bottle 220 indicating the amount of liquid to be added to the coffee beverage concentrate 212. The beverage container lid 240 may comprise a tamper proof screw top or cap 240B. Optionally a beverage container opening seal 250 may cover the beverage container opening 248. As shown at FIG. 8, a safety collar seal 258 may be provided over the bottle 220 and the cap 240B, which has a safety collar top edge 258A, a safety collar bottom edge 258B, and a plurality of safety collar perforations 258C for use to open and remove the safety collar 258 seal for use of the kit 210. A label or printed indicia 262 may be provided on the beverage container side wall 226 which may include product information and directions for use.

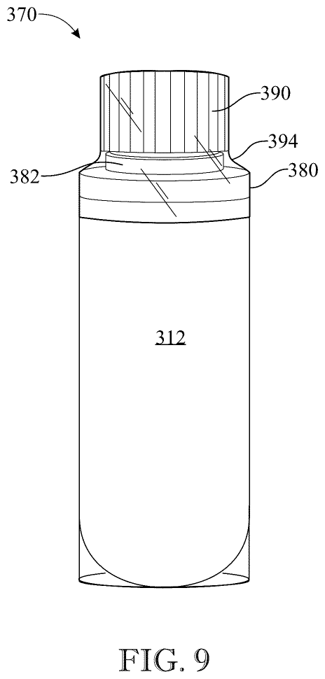

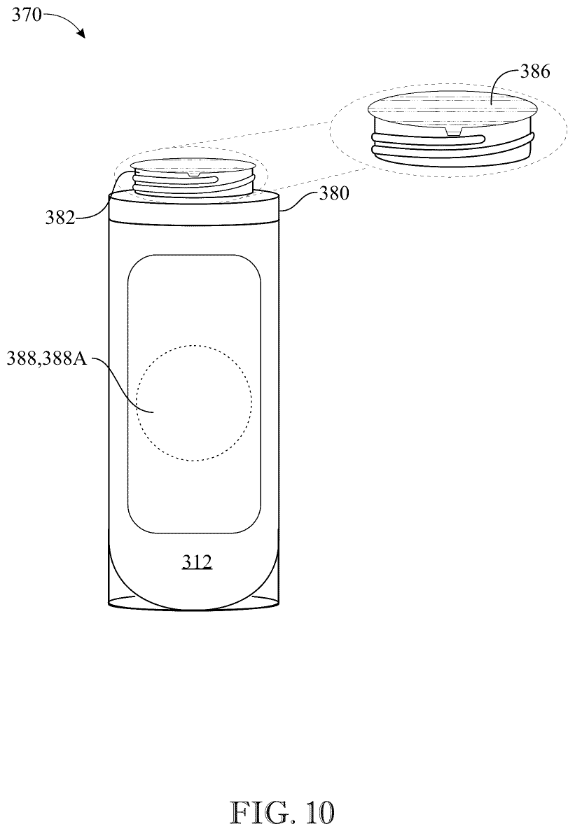

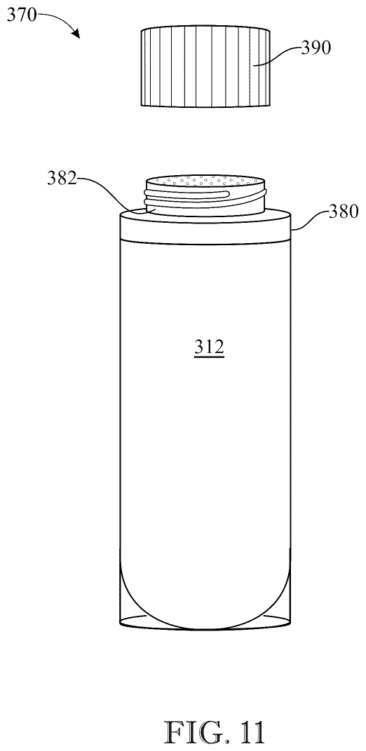

As shown at FIGS. 1-8, the kit 110,210 may comprise a coffee beverage concentrate 112,212 provided in the beverage container assembly 116,216. As shown at FIG. 9-11, in some embodiments, a kit 310 may comprise a coffee beverage concentrate 312 provided in a separate concentrate container assembly 370. In some embodiments, the coffee beverage concentrate 312 in a concentrate container assembly 370 may be provided on its own, without the kit. The concentrate container assembly may comprise a concentrate container 380 and a concentrate container lid 390. The concentrate container assembly 370 may be any suitable container assembly. In some embodiments, the concentrate container assembly 370 may comprise a three (3) ounce bottle configured to retain a liquid beverage concentrate or liquid starter 312. The three ounce container may comprise any suitable material, such as, for example without limitation, a clear, transparent or translucent material; or may comprise an aluminum bottle. The concentrate container lid 390 may comprise a tamper proof screw top configured to be secured to a threaded neck 382 of the concentrate container 380. Optionally the container may be provided with a seal 386 covering the concentrate container opening 384. As shown at FIG. 10, a label 388 may be provided which includes product indicia 388A and directions for use. Optionally, a safety collar seal 394 may be shrink-wrapped to seal the concentrate container lid 390 over the concentrate container 380. Like the safety collar seals 158,258 described hereinabove, the safety collar seal 394 has a safety collar top edge, a safety collar bottom edge, and safety collar perforations for use to open and remove the safety collar seal 394 for use.

The coffee starter kit of the present invention provides a fast personalized, customized, inexpensive, convenient option. In use, a user may add to a coffee beverage composition in the container, a predetermined amount of a liquid defined by a container fill line, the liquid comprising hot or cold water, milk, cream, coffee or combinations thereof, and mixing the composition and liquid contents of the sealed container to quickly prepare a coffee or espresso beverage. The present invention provides fast custom espresso to go in a portable beverage container.

The present invention provides a single serving liquid latte starter of two types. A first type provides a beverage container which contains the liquid starter to which a user or consumer may add eight (8) ounces of any suitable hot or cold liquid, such as for example without limitation, milk, (i.e. organic, skim, 1%, 2%, whole, almond, lactose free), water or coffee. After adding the liquid, the user may simply replace the lid, shake the container, and enjoy the beverage. Alternatively, the second type provides a three (3) ounce bottle which contains a liquid starter composition. The liquid starter composition may be poured in a suitable drinking vessel such as a cup or mug. The user may then add to the vessel eight (8) ounces of liquid, such as warm or cold water, milk (i.e. organic, skim, 1%, 2%, whole, almond, lactose free), or coffee, stir the beverage and enjoy drinking an easily prepared beverage.

In one implementation, the present invention provides a coffee beverage concentrate composition comprising one (1) ounce of brewed espresso and two (2) ounces of a beverage sweetener. The brewed espresso may comprise water and finely ground espresso beans.

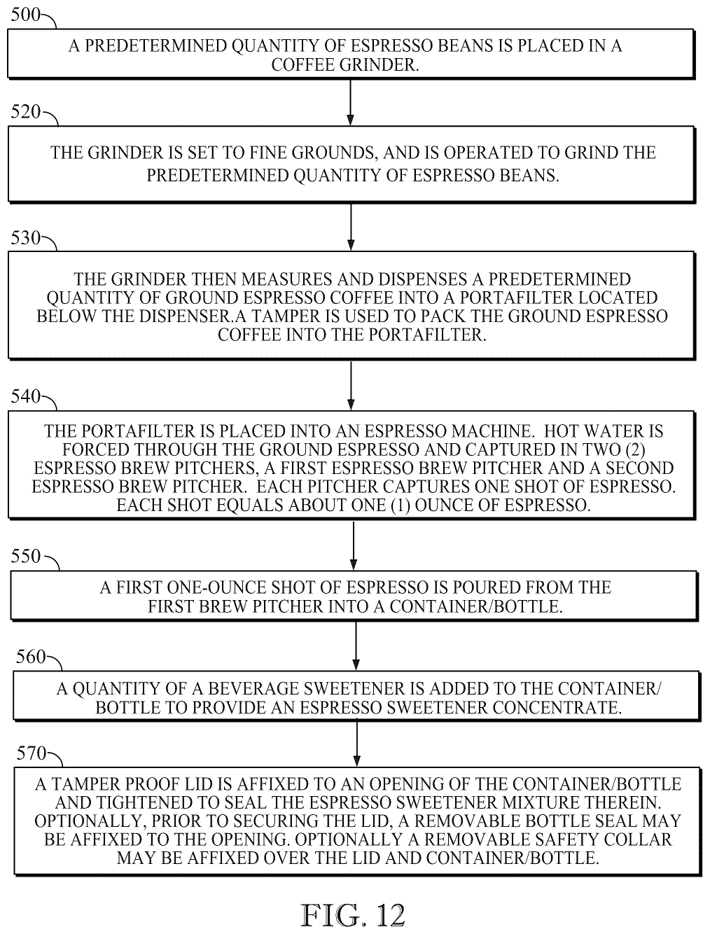

Referring to FIG. 12, in one implementation, the present invention provides a method 500 for preparing a coffee beverage concentrate composition. The method may comprise one or more of the following steps and combinations thereof.
(510) a predetermined quantity of espresso beans is placed in a coffee grinder.
(520) the grinder is set to fine grounds, and operated to grind the predetermined quantity of espresso beans.
(530) the grinder then measures and dispenses from a dispenser a predetermined quantity of ground espresso coffee into a portafilter located below the dispenser. A tamper is used to pack the ground espresso coffee into the portafilter.
(540) the portafilter is then placed into an espresso machine where hot water from the espresso machine is forced through the ground espresso and captured in 2 espresso brew pitchers, a first espresso brew pitcher and a second espresso brew pitcher. Each pitcher captures one shot of espresso. Each shot equals about 1 ounce of espresso.
(550) a first shot of espresso (one (1) oz. is poured into the beverage container or bottle.
(560) providing a predetermined quantity of a beverage sweetener and adding the predetermined quantity of the beverage sweetener to the container or bottle, to provide an espresso beverage concentrate.
(570) after the sweetener is added to the bottle, a tamper proof lid is screwed onto the container or bottle and tightened to seal the contents therein. The container/bottle and tamper proof lid may be any suitable commercially available container/bottle and lids. A removable container/bottle seal may be affixed to the container/bottle opening prior to securing the lid to the bottle. Optionally, a removable shrink-wrap safety collar may be affixed over the lid and the container/bottle.

In some embodiments, providing the sweetener may comprise providing a commercially available beverage sweetener and adding a predetermined quantity of the commercially available beverage sweetener to the espresso shot without a change to its chemical properties. It may merely be measured and poured into the container with the espresso shot. For example, in some embodiments, two pumps of a commercially available beverage sweetener syrup may be added to each container of brewed espresso. In other embodiments, about two (2) ounces of the commercially available beverage sweetener may be added.

In other embodiments, providing the sweetener may comprise providing two (2) ounces of a custom sweetener blend. The custom sweetener blend may be prepared by modifying a sweetener component. The sweetener variations may include the following. The flavors of the sweeteners may be changed depending on the consumer likes and demand for product. The sweetener flavors may be mixed as may be determined by research and development of new varieties of lattes. However, the total amount of sweetener remains consistent (2 oz). Likewise, sugar free variations of the product may be produced as well. However, the total amount of sweetener remains the same (2 oz).

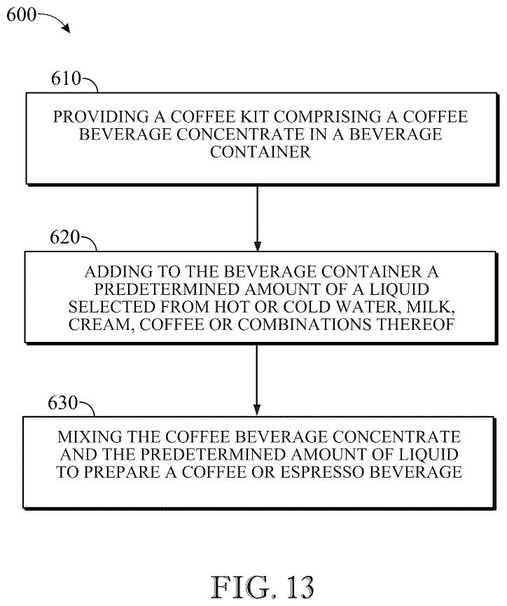

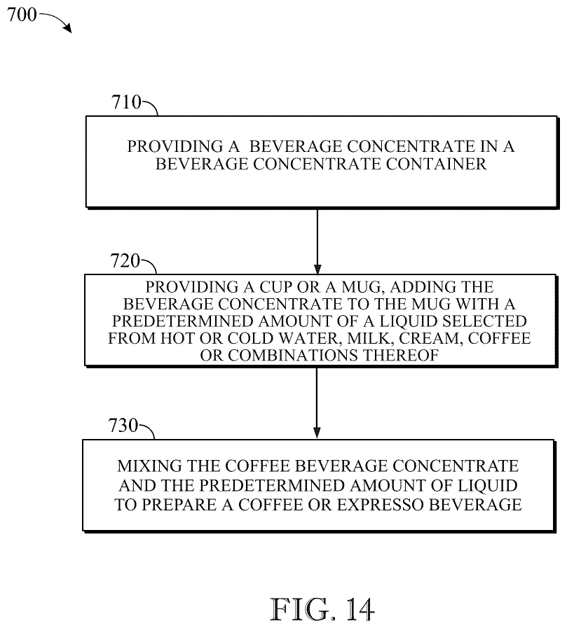

Referring to FIG. 13-14, methods of use are described. As shown at FIG. 13, a method of use 600 comprises:
(610) providing a coffee kit comprising a coffee beverage concentrate in a beverage container;
(620) adding to the beverage container a predetermined amount of a liquid selected from hot or cold water, milk, cream, coffee or combinations thereof; and
(630) mixing the coffee beverage concentrate and the predetermined amount of liquid to prepare a coffee or espresso beverage.

As shown at FIG. 14, a method of use 700 comprises:
(710) providing a beverage concentrate in a beverage concentrate container;
(720) providing a cup or a mug, adding the beverage concentrate to the mug with a predetermined amount of a liquid selected from hot or cold water, milk, cream, coffee or combinations thereof; and
(730) mixing the coffee beverage concentrate and the predetermined amount of liquid to prepare a coffee or espresso beverage.

In an exemplary embodiment, the present invention may comprise methods of packaging a beverage concentrate in a container. All measuring and packaging may be done individually by hand. Alternatively, in response to an increased need for production, the measuring and packaging may be effected by machines capable of automating the production, measuring, filling and packaging of the beverage to bottle. The containers may be any suitable containers.

In summary, a portable instant coffee kit comprises a beverage container and a coffee beverage concentrate. The beverage container comprises a container body having an exterior surface, an interior surface, and at least one container fill line; and a removable container lid configured to seal the container for mixing a beverage therein. A user may use the portable instant coffee kit by: providing the portable instant coffee kit; adding to the coffee beverage concentrate in the container, a predetermined amount of a liquid; and mixing the coffee beverage concentrate and the predetermined amount of a liquid to quickly prepare a coffee or espresso beverage. The predetermined amount of the liquid may be defined by the at least one container fill line. The liquid may comprise hot or cold water, milk, cream, coffee or combinations thereof. The coffee beverage concentrate may be provided in a separate coffee concentrate container, and used by mixing the concentrate in a cup, mug or other suitable container with a predetermined amount of a liquid to quickly prepare a coffee or espresso beverage. The concentrate may be provided in a three (3) ounce bottle.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A portable instant coffee kit comprises:
a beverage container comprising:
a container body having an exterior surface, an interior surface, and at least one container fill line; and
a removable container lid configured to seal the container for mixing a beverage therein; and
a coffee beverage concentrate;
wherein a user may use the portable instant coffee kit by:
providing the portable instant coffee kit;
adding to the coffee beverage concentrate in the container, a predetermined amount of a liquid, the predetermined amount being defined by the at least one container fill line, the liquid comprising hot or cold water, milk, cream, coffee or combinations thereof; and
mixing the composition and liquid contents of the sealed container to quickly prepare a coffee or espresso beverage.
